(19) United States
(12) Patent Application Publication
(10) Pub. No.: US 2016/0357024 A1
(43) Pub. Date: Dec. 8, 2016

(54) 3D DISPLAY GLASSES

(71) Applicants: BOE TECHNOLOGY GROUP CO., LTD., Beijing (CN); HEFEI BOE OPTOELECTRONICS TECHNOLOGY CO., LTD., Anhui (CN)

(72) Inventors: Ming Fang, Beijing (CN); Hanqi Chu, Beijing (CN); Jin-Moo Park, Beijing (CN); Shounian Chen, Beijing (CN); Dong Chen, Beijing (CN)

(73) Assignees: BOE TECHNOLOGY GROUP CO., LTD., Beijing (CN); HEFEI BOE OPTOELECTRONICS TECHNOLOGY CO., LTD., Anhui (CN)

(21) Appl. No.: 15/022,726

(22) PCT Filed: Jul. 23, 2015
(86) PCT No.: PCT/CN2015/084894

§ 371 Date: Mar. 17, 2016

(30) Foreign Application Priority Data
Feb. 5, 2015 (CN) 201510061259.1

(51) Int. Cl. G02B 27/22; G02B 27/30

(52) U.S. Cl. CPC G02B 27/2235; G02B 27/30

(57) ABSTRACT

The present application discloses 3D display glasses include an eyeglass frame; a first image projection unit and a second image projection unit respectively fixed on the eyeglass frame, for projecting a first beam carrying a first image and a second beam carrying a second image, respectively; and a first lens and a second lens which maintain fixed onto the eyeglass frame, for receiving the first beam and the second beam, respectively, wherein the first lens and the second lens are configured to collimate respective one of the first beam and the second beam into a beam of parallel light which in turn travels into respective one of the left and the right eyes of the wearer of the 3D display glasses. The 3D display glasses may display images independent of any display screen such that excellent portability and superior 3D-display visual effect may be obtained.

### CROSS-REFERENCE TO RELATED APPLICATION

This application is a Section 371 National Stage Application of International Application No. PCT/CN2015/084894, filed on Jul. 23, 2015, entitled “3D DISPLAY GLASSES”, which has not yet published, and which claims priority to Chinese Patent Application No. 201510061259.1 filed on Feb. 5, 2015, incorporated herein by reference in their entirety.

### BACKGROUND OF THE INVENTION

Field of the Invention

Embodiments of the present application relate to the technical field of display device, and in particular, to three dimensional (3D) display glasses.

Description of the Related Art

In the prior art, 3D display technology has become a fast developing technology which becomes gradually mature and thus has become an increasingly important trend in the display field. The fundamental principle for 3D display lies in: the 3D vision results from the parallax, i.e. a left eye of a viewer only sees a left eye image and a right eye only sees a right eye image, wherein the left eye image and the right eye image are a pair of stereoscopic images with parallax. According to the image output principle at the output end, e.g., the display, 3D display device can be divided into two types, i.e., a serial 3D output or a parallel 3D output.

As to a display of the serial 3D output type, it achieves the 3D display in a time serial manner, in which at a first time slot, a display device displays an image for the left eye, when only the left eye of a viewer can see this left-eye image, and at a second time slot, the display device displays another image for the right eye, when only the right eye of a viewer can see this right-eye image, such that the images to be viewed by the left and the right eyes respectively are played back in an alternate manner switching between a left image frame and a right image frame, and thus, due to the visual persistence of the viewer's eyes, the viewer feels that the left and right eye pictures are seen at the same time, and thereby a 3D vision can be generated. Therefore, a display of the serial 3D output type is commonly referred to as “active time-sliced/time-divided 3D display”

While in contrast, as to a display of the parallel 3D output type, it can be mainly sub-divided into two sub-categories as “color-separation type parallel 3D output” and “light-splitting type parallel 3D output”. A display of the “color-separation type parallel 3D output” type can take advantage of the principle of light-filtering synchronously, e.g., with a filter wheel which is provided with multilayer coatings, to filter part of the RGB color light from a light source as a function of the difference in wavelength of the constituent color light, consequently, the right R, right G and right B constituent color beams create a right optical beam while the left R, left G and left B constituent color beams create a left optical beam, and thus, either of the two optical beams corresponds with respective one lens of the coated color-separation glasses worn by the viewer, such that the right and left optical beams are respectively incident into the left eye and the right eye of the wearer of such color-separation glasses, forming 3D vision (stereoscopic impression). A display of the “light-splitting type parallel 3D output” type, for example, comprises earlier polarized display being provided with horizontal polaroid sheet and vertical polaroid sheet which are arranged perpendicular to each other, and recent circular polarization display which can output both left-handed and right-handed rotation polarized lights at the same time. Within all the polarized displays, their fundamental principles are essentially the same, i.e., the light from light source is polarized at the polaroid optical element in the display such that at the same time the display device displays an image for the left eye and an image for the right eye in different regions thereof, and preferably, the images are displayed precisely in pixel level, i.e., a portion of pixels on the display screen is used for displaying the polarized light for the left eye of the viewer while another portion of pixels on the display screen is used for displaying the polarized light for the right eye of the viewer, and thus, by using a parallax barrier, e.g., an optical grating, or a polarized glasses, the right eye and the left eye of a viewer at the receiving end of images can respectively see the images for the right eye and the images for the left eye so as to realize the 3D display effect.

Therefore, a display of the parallel 3D output type is commonly referred to as “passive 3D display”, such as aforementioned “passive color-separation 3D display” and “passive light-splitting 3D display”.

Moreover, according to the imaging principle of human eyes at the receiving end, e.g., the glasses, 3D display device can mainly be divided into two types, i.e., eyeglass type 3D display device and naked-eye 3D display device.

As to the eyeglass type 3D display device, it can be further sub-divided into two sub-categories as a function of their operating principles, i.e., shutter glasses and shutter-free glasses.

The shutter glasses are provided with a scanning device which cooperates with aforementioned serial 3D output type display; said scanning device opens and shuts off respective display function of the two lenses of such glasses, as a function of a particular frequency determined by a synchronization signal of the image frames for the left and the right eyes, such that each image frame can only pass through respective one single lens every time, obtaining the technical effect of observing the left and the right image frames from both lenses almost simultaneously by human eyes, so as to realize 3D display. Such shutter glasses belong to active 3D glasses, which needs fine debugging and adaption of both the shutter glasses and the cooperative active time-divided 3D display screen. Besides, the requirement for the refresh rate of the scanning device of the glasses is relatively high if a 3D display which is capable of bringing about better degree of comfort upon viewing 3D images is needed.

And the shutter-free glasses mainly comprises “light-splitting glasses” and “color-separation glasses”, wherein the former one can perform light-filtering or light-splitting function upon cooperation with above “light-splitting type parallel 3D output” display, such as passive polarization display. For example, by two sets of polarizer sheets which are arranged orthogonal to each other to filter the polarized light, which is perpendicular to the polarization angle of polarizer sheets, from the display device, two different sets of images can be viewed by two eyes respectively. Hence it can be seen that such “light-splitting glasses” belong to passive 3D glasses, which is commonly referred to as “polaroid 3D glasses”. And the latter one, i.e., the “color-separation glasses”, take advantage of the two differently coated color-separation lenses which are provided with different color-light filtering properties, and thus also belong to a color-separation 3D glasses.

Both of the “polaroid 3D glasses” and the “color-separation 3D glasses” are passive 3D glasses and deliver the two separated beams carrying different images onto the left and the right eyes, such that the captured images by two eyes are subsequently overlapped in the brain of the wearer and thus together creates a sense of depth that the brain perceives as 3D vision.

And the naked-eye 3D display device can operate independently without resorting to 3D glasses, i.e., it takes advantage of the naked-eye 3D display technology, with a principle of projecting different images onto respective left or right eye by a light-splitting means so as to realize 3D display. In the prior art, it comprises several sub-categories, too, such as optical barrier, cylindrical lenses, Directional Backlight, etc.

However, in the prior art, whether a user views 3D images by wearing 3D glasses or by direct utilization of naked-eye 3D display, an external image output display device, e.g., a 3D display screen with relatively large volume, is necessary in the 3D display scenarios in the prior art, which may realize the function of 3D display, inevitably at the cost of or with compromise in resolution, luminance or angle of view.

### SUMMARY OF THE INVENTION

The present application has been made to overcome or alleviate at least one aspect of the above mentioned disadvantages and/or shortcomings One main object of the exemplary embodiment of the present application is to provide 3D display glasses which are capable of realizing 3D display independently of any external display apparatus, such that better 3D display experience can be obtained.

According to an aspect of the exemplary embodiment of the present application, there are provided 3D display glasses, comprising an eyeglass frame; a first image projection unit and a second image projection unit respectively fixed on the eyeglass frame, for projecting a first beam carrying a first image and a second beam carrying a second image, respectively; and a first lens and a second lens which maintain fixed onto the eyeglass frame, for receiving the first beam and the second beam, respectively; the first lens and the second lens are configured to collimate respective one of the first beam and the second beam into a beam of parallel light which in turn travels into respective one of the left and the right eyes of the wearer of the 3D display glasses.

According to another exemplary embodiment of the present application, a length of an optical path between a first beam emission position of the first image projection unit and a center of the first lens is equal to a focal length of the first lens, while a length of an optical path between a second beam emission position of the second image projection unit and a center of the second lens is equal to a focal length of the second lens.

According to another exemplary embodiment of the present application, the 3D display glasses further comprises a first reflection unit which is configured to reflect the first beam from the first image projection unit to the first lens, and a second reflection unit which is configured to reflect the second beam from the second image projection unit to the second lens.

According to another exemplary embodiment of the present application, the first reflection unit is provided with a first reflecting surface for reflection of the first beam, the first reflecting surface of the first reflection unit intersecting at an angle with an optical axis of the first lens at a first intersection point; and the second reflection unit is provided with a second reflecting surface for reflection of the second beam, the second reflecting surface of the second reflection unit intersecting at an angle with an optical axis of the second lens at a second intersection point.

According to another exemplary embodiment of the present application, a sum of a length of an optical path between the first beam emission position of the first image projection unit and the first intersection point and a length of an optical path between the first intersection point and a center of the first lens is equal to a focal length of the first lens; and a sum of a length of an optical path between the second beam emission position of the second image projection unit and the second intersection point and a length of an optical path between the second intersection point and a center of the second lens is equal to a focal length of the second lens.

According to another exemplary embodiment of the present application, in a radial direction perpendicular to the optical axis of the first lens, both of the first image projection unit and the second image projection unit are positioned outside the first reflection unit; and in a radial direction perpendicular to the optical axis of the second lens, both of the first image projection unit and the second image projection unit are positioned outside the second reflection unit.

According to another exemplary embodiment of the present application, the first reflection unit is provided with a first bonding surface while the second reflection unit is provided with a second bonding surface, the first lens being provided on the first bonding surface and the second lens being provided on the second bonding surface, respectively.

According to another exemplary embodiment of the present application, each of the first reflection unit and the second reflection unit is an optical element chosen from a group comprising a reflecting prism and a reflective plate.

According to another exemplary embodiment of the present application, the first beam originating from a first beam emission unit travels within the first reflection unit and is reflected on a reflecting surface inside the first reflection unit into the first lens which abuts against the first bonding surface closely; and the second beam originating from a second beam emission unit travels within the second reflection unit and is reflected on a reflecting surface inside the second reflection unit into the second lens which abuts against the second bonding surface closely.

According to another exemplary embodiment of the present application, both of the first bonding surface and an incident surface of the first lens to be bonded therewith are planar surfaces, and both of the second bonding surface and an incident surface of the second lens to be bonded therewith are planer surfaces.

According to still another exemplary embodiment of the present application, the first bonding surface is a curved surface which is in a positive fit with the shape of the incident surface of the first lens to be bonded therewith, and the second bonding surface is a curved surface which is in a positive fit with the shape of the incident surface of the second lens to be bonded therewith.

According to still another exemplary embodiment of the present application, focal lengths of both of the first lens and the second lens are between 24 mm and 26 mm.

According to yet another exemplary embodiment of the present application, divergence angles of both of the first beam and the second beam are between 5° and 11°.

According to still yet another exemplary embodiment of the present application, an optical axis of the first lens is parallel with an optical axis of the second lens.

In at least one of above embodiments of the present application, two beams which carry two sets of different images respectively are delivered to the left eye and the right eye of the wearer of the glasses, respectively, by two individual optical paths which are independent from each other, so as to realize 3D display. The 3D display glasses according to the embodiments of the present application can perform display function without any external display arranged separately for delivery of beams carrying images, thus better portability and 3D display effect can be obtained.

### BRIEF DESCRIPTION OF THE DRAWINGS

The above and other features and advantages of the present application will become more apparent and a more comprehensive understanding of the present application can be obtained, by describing in detail exemplary embodiments thereof with reference to the accompanying drawings, in which:

FIG. 1 illustrates a schematic perspective view of 3D display glasses according to one exemplary embodiment of the present application; and

FIG. 2 illustrates a schematic perspective view of exemplary reflection unit and lens of the 3D display glasses according to one exemplary embodiment of the present application.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms, and thus the detailed description of the embodiment of the application in view of attached drawings should not be construed as being limited to the embodiment set forth herein; rather, these embodiments are provided so that the present disclosure will be thorough and complete, and will fully convey the general concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Respective thickness and shape of each optical element in the drawings are only intended to exemplarily illustrate the contents of the disclosure, rather than to demonstrate the practical dimension or proportion of components of the 3D glasses.

According to a general technical concept of the present application, there are provided 3D display glasses, comprising: an eyeglass frame; a first image projection unit and a second image projection unit respectively fixed on the eyeglass frame, for projecting a first beam carrying a first image and a second beam carrying a second image, respectively; and a first lens and a second lens which maintain fixed onto the eyeglass frame, for receiving the first beam and the second beam, respectively, wherein the first lens and the second lens are configured to collimate respective one of the first beam and the second beam into a beam of parallel light which in turn travels into respective one of the left and the right eyes of the wearer of the 3D display glasses.

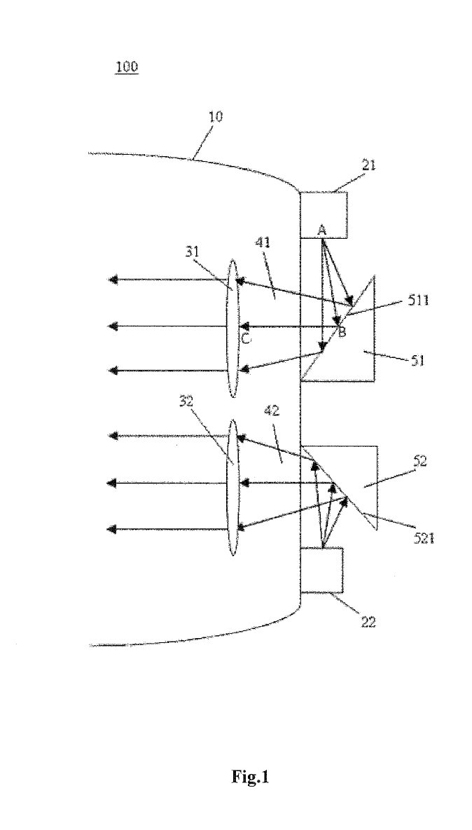

FIG. 1 illustrates a structural schematic view of 3D display glasses 100 according to one exemplary embodiment of the present application. For example, the 3D display glasses 100 comprise an eyeglass frame 10, a first image projection unit 21, a second image projection unit 22, a first lens 31 and a second lens 32. The first image projection unit 21, the second image projection unit 22, the first lens 31 and the second lens 32 are fixed onto the eyeglass frame 10. Specifically, on each side of the eyeglass frame 10, one of two lateral temples and a peripheral edge of one of two lens receptacles intersect each other at a corner, where the first image projection unit 21 and the second image projection unit 22 are mounted in front of the eyeglass frame 10, respectively. Furthermore, a first lens 31 and a second lens 32 are positioned within the 3D display glasses 100, in front of eyes of the wearer of the glasses 100 while respectively behind two lenses which are optical lenses such as refractive lenses, plano-lenses, and concave lenses for the shortsighted and are accommodated within the two receptacles respectively at each side. The first image projection unit 21 and the second image projection unit 22 are configured to project a first beam 41 carrying a first image and a second beam 42 carrying a second image, respectively. And the first lens 31 and the second lens 32 are respectively provided for receiving the first beam 41 and the second beam 42, and configured to further collimate the first beam 41 into a beam of parallel light while collimate the second beam 42 into another beam of parallel light, which two beams of parallel light are in turn directed to the left and the right eyes of the wearer, respectively. In the exemplary embodiment as illustrated by FIG. 1, the left and the right eyes of the wearer are located at the imaging side behind the first lens 31 and the second lens 32, respectively.

The fundamental principle of 3D display is to film (i.e., to capture images or videos) by means of two imaging devices e.g., camera(s), or to conduct image separation with an image separating device, so as to produce two sets of images for both the left and the right eyes, respectively; and then to provide the left and the right eyes of the wearer with such two sets of images, simultaneously or at fixed time intervals which cannot be identified by human eyes, such that the captured images by human visual perception are subsequently overlapped in pairs in the brain and thus together creates a sense of depth that the brain perceives as 3D. The principle of the 3D display effect intended to be achieved by the present application is essentially the same, i.e., to capture two sets of images for both the left and the right eyes respectively, e.g., by two small or miniature image projection units, and provide such two sets of image to respective eye so as to product 3D display effect which can be viewed by the wearer of the glasses.

The 3D display glasses according to the embodiments of the present application construct two optical paths corresponding to the left and the right eyes of the wearer by utilizing two image projection units and two respective lenses such that the left and the right eyes can observe different images completely independently from each other. Since the two optical paths corresponding to the left and the right eyes are individually constructed, then, in the 3D display glasses according to the exemplary embodiment of the application, two sets of images which are to be observed by the left and the right eyes respectively are thus formed without the need for decomposition of the beam(s) at the cost of or with compromise in resolution, luminance or angle of view. Besides, higher resolution, greater luminance and wider angle of view thus produced in turn bring about finer 3D display effect with larger depth of field, clearer stereovision, and stronger spatial immersion feeling of the wearer, thus improving the degree of comfort of the wearer upon viewing 3D images. Moreover, said 3D display glasses realizes the function of 3D display by producing two sets of images independently from each other only by two small or miniature image projection units mounted at the two corners where the lateral temples and peripheral edges of the lens receptacles intersect each other, rather than by external discrete image generation apparatus such as cumbersome display screen, large-scale light decomposition equipment. Thereby, the portability of the glasses, as a complete 3D display device with both transmitting end and receiving end, is enhanced.

In an exemplary embodiment of the application, a length of an optical path between a first beam emission position of the first image projection unit 21 and the center of the first lens 31 is, for example, equal to a focal length of the first lens 31. The first image shows most clearly to the human eye (the left or the right eye) proximate to the imaging side behind the first lens 31 in the case that the first image projection unit 21 and the first lens 31 fulfill the above positional relationship therebetween. Hereby better viewing result can be obtained by the wearer. Likewise, a length of an optical path between a second beam emission position of the second image projection unit 22 and the center of the second lens 32 is also equal to a focal length of the second lens 32, by way of example.

In an illustrated embodiment, for example, said 3D display glasses further comprise a first reflection unit 51 which is configured to reflect the first beam 41 from the first image projection unit 21 to the first lens 31, and a second reflection unit 52 which is configured to reflect the second beam 42 from the second image projection unit 22 to the second lens 32. Specifically, as illustrated in FIG. 1, by way of example, said first reflection unit 51 and the second reflection unit 52 are positioned in front of or accommodated within respective lens receptacle of the 3D display glasses 100, and their respective reflecting surfaces, i.e., the first reflecting surface of the first reflection unit 51 and the second reflecting surface of the second reflection unit 52, are deflected at an angle from corresponding lens receptacles and the first lens 31 or second lens 32 immediately behind the corresponding lens receptacles, such that optical paths of the two beams from the first image projection unit 21 and the second image projection unit 22 are changed by reflection and directed to respective incident side of the first lens 31 and the second lens 32, respectively. At the same time, each of said first reflection unit 51 and the second reflection unit 52 narrows the cross section, orthogonal to the propagation direction of respective optical path, of the first beam 41 and the second beam 42 in the optical path after respective reflecting surface, as compared with the cross section in the optical path of divergent beam projecting from the first reflection unit 51 or the second reflection unit 52 onto respective reflecting surface, thus reducing the projection dimension, e.g., the coverage area of projection beam, of optical path on the cross section orthogonal to the direction of the optical axis of the first lens 31 or the second lens 32, and in turn decreasing the volume of said 3D display glasses while providing a redundant space for relative displacement of internal components within the glasses such that the spatial arrangement flexibility of components can be enhanced.

By way of example, said first reflection unit 51 is provided with a first reflecting surface 511 for reflecting the first beam 41, which first reflecting surface 511 intersects at an angle with an optical axis of the first lens 31; and said second reflection unit 52 is provided with a second reflecting unit 521 for reflecting the second beam 42, which second reflecting surface 521 of said second reflection unit 52 also intersects at an angle with an optical axis of the second lens 32. And the main directions of the reflected beams after said first and second reflecting surfaces 511, 521 still remain along their optical axes respectively, so as to ensure that the two beams of parallel light, which are emerging from the first reflecting surface 511 and the second reflecting surface 521 and collimated by the first lens 31 and the second lens 32 respectively, are directed to the left and the right eyes, improving the efficiency or utilization rate of light beam and facilitating the substantial alignment between visual field of human eyes and collimated beams of parallel imaging light at the imaging side behind the lenses to maximize the viewing angle, luminance and field of view of 3D images, so as to improve the 3D display effect and degree of comfort upon viewing.

In an exemplary embodiment of the application, a sum of a length of an optical path along which the center of the first beam travels between the first beam emission position (i.e., the position A as illustrated in FIG. 1) of the first image projection unit 21 and a first intersection point (i.e., the position B as also illustrated in FIG. 1) where the first reflecting surface 511 intersects an optical axis of the first lens 31 and a length of another optical path between said first intersection point B and the center (i.e., the position C as illustrated in FIG. 1) of the first lens 31 is, for example, essentially equal to the focal length of the first lens 31; i.e., as shown in FIGS. 1, in the beam emerging from the emission position A, the optical path of the light which is centered on a cross section essentially orthogonal to the propagation direction of beam can be determined as Line AB plus Line BC, and the sum of the lengths of the optical path of Line AB plus Line BC is equal to the focal length of the first lens 31. Thereby, if the first image projection unit 21, the first reflecting surface 511 and the first lens 31 are positioned as a function of above relative positioning thereamong, the clearest imaging of the first beam can be obtained. Likewise, by way of example, a sum of a length of an optical path along which the center of the second beam travels between the second beam emission position of the second image projection unit 22 and a second intersection point where the second reflecting surface 512 intersects an optical axis of the second lens 32 and a length of an optical path between the second intersection point and the center of the second lens 32 is also for example equal to a focal length of the second lens 32.

In an example as shown in FIG. 1, in the radial direction perpendicular to the optical axis of the first lens 31, each of the first image projection unit 21 and the second image projection unit 22 is positioned outside the first reflection unit 51 and in front of respective lens receptacle of the 3D display glasses 100; while in the radial direction perpendicular to the optical axis of the second lens 32, each of the first image projection unit 21 and the second image projection unit 22 is positioned outside the second reflection unit 52 and in front of respective lens receptacle. Thereby, for example, the first image projection unit 21 and the second image projection unit 22 are positioned to deflect from the front (relative to the straight forward direction upon viewing by the eyes of the wearer of the glasses) of the first and the second lenses 31, 32, respectively, to avoid any obstruction of the wearer's eyes, such that the wearer can view the 3D image while seeing through the glasses simultaneously to obtain a good vision of the surroundings, and can even engage in other work.

The first image projection unit 21 and the second image projection unit 22 are positioned at both sides of the first and second reflection units 51, 52, respectively in an exemplary embodiment as illustrated in FIG. 1; however, such positioning is not necessary. For example, the first image projection unit 21 is located on either side of the first reflection unit 51 in a plane which is orthogonal to the optical axis of the first lens 31, if only the obstruction of eyes by the first image projection unit 21 can be avoided. The same condition is true for the second image projection unit 22 and thus need not be repeated here.

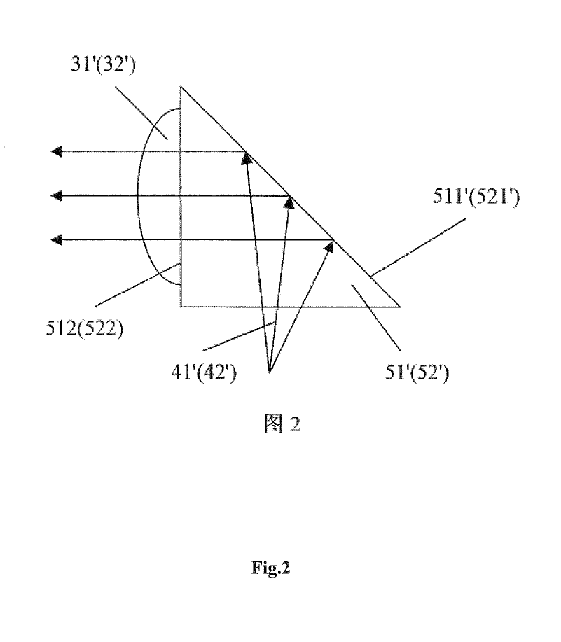

In an alternative exemplary embodiment, as shown in FIG. 2, for example, the first reflection unit 51′ is provided with a first bonding surface 512 while the second reflection unit 52′ is provided with a second bonding surface 522. The first lens 31′ abuts at its incident surface against said first bonding surface 512 of the first reflection unit 51′, while the second lens 32′ also abuts at its incident surface against the second bonding surface 522 of the second reflection unit 52′. Since the first reflection unit 51′ and the second reflection unit 52′ are provided with substantially identical or symmetrical structures, in FIG. 2, only one reflection unit is illustrated, which can be viewed as either the first reflection unit 51′ or the second reflection unit 52′. The first reflection unit 51′ abuts against the first lens 31′ while the second reflection unit 52′ abuts against the second lens 32′, thus the processibility of the glasses can be enhanced and the relative positions among the components thereof are prone to remain unchanged. Moreover, by transiting one reflection conducted outside of the reflection unit into another reflection performed within a reflecting prism, i.e., by passing the incident beam 41′ and 42′ from the emission position A through the interior of the reflecting prism, converting them into reflected beams on the internal reflecting surface of said reflecting prism, which reflected beams subsequently enter the first lens 31′ and the second lens 32′ which abut against the bonding surfaces of said reflecting prism, respectively, reducing both of the distances AB and BC effectively shown in FIG. 1, such that the relative distances between any two optical elements within the 3D display glasses can be significantly decreased without significant reduction of the length of optical path, resulting in 3D display glasses of proper volume. Only one exemplary embodiment is illustrated in FIG. 2, i.e., when the first reflection unit 51′ (or the second reflection unit 52′) is a reflecting prism, one side surface thereof functions as the first bonding surface 512 (or the second bonding surface 522); however, the applicant is not limited or confined thereto. The first bonding surface 512 (or the second bonding surface 522) can be located in any positional relationship with the first reflecting surface 511′ (or the second reflecting surface 521′), if only the above reflection function and the collimation function of the first lens 31′ (or the second lens 32′) can be realized, for example.

It should be noted that, though in the exemplary embodiment as illustrated in FIG. 2, the first bonding surface 512 (or the second bonding surface 522) is chosen as a planar surface; however, the application is not confined thereto. For example, the first bonding surface 512 (or the second bonding surface 522) is a curved surface, whose contour is determined as a function of the shape of the first lens 31′ (or the second lens 32′), i.e., in a positive fit with the shape of the incident surface of the first lens 31′ (or the second lens 32′) to be bonded therewith. As an example, the first lens 31′ (or the second lens 32′) can be a convex lens, e.g., a Fresnel lens being provided with a convex surface on one side, or a lens having convex surfaces on both sides.

It should also be noted that, it is not necessary to position the first lens 31′ (or the second lens 32′) by means of the first bonding surface 512 (or the second bonding surface 522); in other words, for instance, the first reflection unit 51′ is not provided with the first bonding surface 512 or the second reflection unit 52′ is not provided with the second bonding surface 522, and the first lens 31′ or the second lens 32′ is mounted in other way, e.g., directly mounted onto the eyeglass frame 10.

By way of example, each of the first reflection units 51, 51′ and the second reflection units 52, 52′ is formed by a reflecting prism or a reflective plate, which may facilitate construction of more compact reflection unit. However, the present application is not limited thereto, and it is also possible to form each first reflection unit 51, 51′ and each second reflection unit 52, 52′ by other reflection element known in the art, for example.

In an exemplary embodiment of the application, the focal lengths of the first lenses 31, 31′ and the second lenses 32, 32′ are all adapted for the Pupil Distance of human eyes and the dimension of each image projection unit, e.g., each focal length is between 24 mm and 26 mm. Furthermore, by way of example, divergence angles of both of the first beam 41 and the second beam 42 are adapted to match the Pupil Distance of human eyes, e.g., between 5° and 11°.

In an exemplary embodiment of the application, the optical axis of the first lens 31 or 31′ is parallel with the optical axis of the respective second lens 32 or 32′, so as to enhance the degree of comfort upon viewing by human eyes through the 3D display glasses according to the present application.

By way of example, the eyeglass frame 10 can be made of various materials such as plastics, resin, metal, and the like, and functions as stabilizing support of other components within the 3D display glasses, such as the first image projection unit 21, the second image projection unit 22, the first lens 31 or 31′, and the second lens 32 or 32′, the first reflection unit 51 or 51′, and the second reflection unit 52, 52′, etc.

Since both optical paths of two sets of images respectively for both eyes are formed completely independent from each other while eliminating the need for an external display screen, the 3D display glasses are capable of mitigate or eliminate the 3D crosstalk between the two sets of images for both eyes and the interference introduced by external stray light, e.g., which tray light is brought about by the external display screen.

In an exemplary embodiment, the first image projection unit 21 and the second image projection unit 22 can be image projection apparatus known in the art, e.g., miniature projector

The 3D display glasses according to the present application can be applied onto a variety of application scenarios which requires 3D display technology, such as, 3D movies, 3D Television programs, 3D live action telecast, observation of Augmented Reality, and the like.

Although the disclosure is described in view of the attached drawings, the embodiments disclosed in the drawings are only intended to illustrate the preferable embodiment of the present application exemplarily, and should not be deemed as a restriction thereof.

Various embodiments of the present application have been illustrated progressively, the same or similar parts of which can be referred to each other. The differences between each embodiment and the others are emphasisly described.

It should be noted that the terms, such as “comprising”, “including” or “having”, should be understood as not excluding other elements or steps and the word “a” or “an” should be understood as not excluding plural of said elements or steps. Further, any reference number in claims should be understood as not limiting the scope of the present application.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments of the general concept of the present application have been shown and described, it would be appreciated by those skilled in the art that various changes or modifications may be made in these embodiments without departing from the principles and spirit of the disclosure, the scope of which is defined in the claims and their equivalents.

1. Three dimensional (3D) display glasses, comprising:
an eyeglass frame;
a first image projection unit and a second image projection unit respectively fixed on the eyeglass frame, for projecting a first beam carrying a first image and a second beam carrying a second image, respectively; and
a first lens and a second lens which maintain fixed onto the eyeglass frame, for receiving the first beam and the second beam, respectively,
wherein the first lens and the second lens are configured to collimate respective one of the first beam and the second beam into a beam of parallel light which in turn travels into respective one of the left and the right eyes of the wearer of the 3D display glasses.

2. The 3D display glasses according to claim 1, wherein a length of an optical path between a first beam emission position of the first image projection unit and a center of the first lens is equal to a focal length of the first lens, while a length of an optical path between a second beam emission position of the second image projection unit and a center of the second lens is equal to a focal length of the second lens.

3. The 3D display glasses according to claim 1, further comprising a first reflection unit which is configured to reflect the first beam from the first image projection unit to the first lens, and a second reflection unit which is configured to reflect the second beam from the second image projection unit to the second lens.

4. The 3D display glasses according to claim 3, wherein the first reflection unit is provided with a first reflecting surface for reflection of the first beam, the first reflecting surface of the first reflection unit intersecting at an angle with an optical axis of the first lens at a first intersection point; and
wherein the second reflection unit is provided with a second reflecting surface for reflection of the second beam, the second reflecting surface of the second reflection unit intersecting at an angle with an optical axis of the second lens at a second intersection point.

5. The 3D display glasses according to claim 4, wherein a sum of a length of an optical path between the first beam emission position of the first image projection unit and the first intersection point and a length of an optical path between the first intersection point and a center of the first lens is equal to a focal length of the first lens; and
wherein a sum of a length of an optical path between the second beam emission position of the second image projection unit and the second intersection point and a length of an optical path between the second intersection point and a center of the second lens is equal to a focal length of the second lens.

6. The 3D display glasses according to claim 4, wherein in a radial direction perpendicular to the optical axis of the first lens, both of the first image projection unit and the second image projection unit are positioned outside the first reflection unit; and
wherein in a radial direction perpendicular to the optical axis of the second lens, both of the first image projection unit and the second image projection unit are positioned outside the second reflection unit.

7. The 3D display glasses according to claim 3, wherein the first reflection unit is provided with a first bonding surface while the second reflection unit is provided with a second bonding surface, the first lens being provided on the first bonding surface and the second lens being provided on the second bonding surface, respectively.

8. The 3D display glasses according to claim 3, wherein each of the first reflection unit and the second reflection unit is an optical element chosen from a group comprising a reflecting prism and a reflective plate.

9. (canceled)

10. (canceled)

11. (canceled)

12. The 3D display glasses according to claim 7, wherein the first beam originating from a first beam emission unit travels within the first reflection unit and is reflected on a reflecting surface inside the first reflection unit into the first lens which abuts against the first bonding surface closely; and
wherein the second beam originating from a second beam emission unit travels within the second reflection unit and is reflected on a reflecting surface inside the second reflection unit into the second lens which abuts against the second bonding surface closely.

13. The 3D display glasses according to claim 7, wherein both of the first bonding surface and an incident surface of the first lens to be bonded therewith are planar surfaces, and
wherein both of the second bonding surface and an incident surface of the second lens to be bonded therewith are planer surfaces.

14. The 3D display glasses according to claim 7, wherein the first bonding surface is a curved surface which is in a positive fit with the shape of the incident surface of the first lens to be bonded therewith, and
wherein the second bonding surface is a curved surface which is in a positive fit with the shape of the incident surface of the second lens to be bonded therewith.

15. The 3D display glasses according to claim 1, wherein focal lengths of both of the first lens and the second lens are between 24 mm and 26 mm.

16. The 3D display glasses according to claim 1, wherein divergence angles of both of the first beam and the second beam are between 5° and 11°.

17. The 3D display glasses according to claim 1, wherein an optical axis of the first lens is parallel with an optical axis of the second lens.
